(19) United States
(12) Patent Application Publication
(10) Pub. No.: US 2005/0003991 A1
(43) Pub. Date: Jan. 6, 2005

(54) Film-form compositions for delivery of soaps and detergents

(76) Inventor: Reg MacQuarrie, Toronto (CA)

Correspondence Address: Law Office - Dinesh Agarwal, P.C., Suite 330, 5350 Shawnee Road, Alexandria, VA, 22312, US

(21) Appl. No.: 10/816,166

(22) Filed: Apr. 2, 2004

Related U.S. Application Data
(60) Provisional application No. 60/459,630, filed on Apr. 3, 2003.

(51) Int. Cl. C11D 17/00

(52) U.S. Cl. 510/438

(57) ABSTRACT

Rapidly water soluble strips of film carrying surfactants are described for application as soaps and detergents. A preferred water soluble polymer base for the film compositions comprises a carbohydrate based hydrocolloid such as hydroxy propyl methyl cellulose or sodium carboxymethyl cellulose. Suitable base polymers are quick dissolving and can carry high polymer loadings and leave virtually no residue upon rapid dissolution in water. The addition of a small amount of plasticizer to the composition imparts the degree of flexibility required for practical applications.

### RELATED APPLICATION

This application claims priority based on U.S. provisional patent application No. 60/459,630 filed on Apr. 3, 2003, which is hereby incorporated herein in its entirety by reference.

### BACKGROUND OF THE INVENTION

This invention relates to rapid dissolving film formulations for the quick and convenient delivery of surfactants upon the addition of water, e.g. a soap for personal washing applications or detergent for use in cleaning clothes or in other household cleaning applications.

In the form of personal wash strips (hand soap), films according to the present invention comprise a water soluble film base containing any desired combination of standard or custom soaps, surfactants and wetting agents, optionally in combination with fragrances and oils.

In the form of detergent strips, a water soluble film base carries a concentrated detergent of the type typically used for laundry or dish soaps. The film itself can be a foaming or non-foaming product and may optionally include fragrances or other desired modifiers.

I have found that certain water soluble polymers, particularly carbohydrate based hydrocolloids such as sodium carboxymethyl cellulose and other water soluble carboxymethyl celluloses, will hold sufficient surfactant such as hand soap and be sufficiently quickly dissolving to rapidly generate a desirable open foam upon the addition of water with agitation (e.g. rubbing of hands together, dissolution in washing machine, etc.).

Film-form compositions have widely been used to carry nutrients, flavors and medicinal compounds, such as breath fresheners, in orally disintegrating or dissolving films, as for example, the edible dissolving gelatin scripts described in my co-pending U.S. patent application Ser. No. 10/695,905. Very different physical parameters are required, however, for films intended to function as soap for personal hygiene or detergent for household cleaning and laundry applications. Compositions according to the present invention are in the form of a thin film which dissolves on contact with water. For personal hygiene applications such as a hand soap, the size of each individual film portion would normally be in the range of six to twelve cm² and in use would completely disappear in under ten seconds when rubbed between the hands of the user with a small amount of water.

Soap and detergent strips according to the present invention afford great convenience of use. In the case of personal soaps, the user need no longer carry around bulky liquid packs as the film compositions can be carried in a pocket or purse. For industrial cleaning applications, the measured film portions provide better dose control, in which users get the exact amount of detergent or soap required based upon the quantity of film used or dispensed.

Dosage control is also of importance in personal applications where soaps include antimicrobials or particularly strong surfactants, where it would not be desirable for the user to obtain more than the portion that is contained on the strip. Related to this consideration is the ability of film-form compositions according to the present invention to be used in mechanical dosing applications in institutions and public restrooms. Less soap and less packaging are used up than by current dispensing techniques to minimize environmental impact.

### DESCRIPTION OF THE INVENTION

Surfactant-bearing strips according to the present invention comprise three essential components:
(i) Water soluble film polymer base. I have found by experimentation that the best polymers for forming a quick dissolving film base as required in these applications belong to the group of carbohydrate based hydrocolloids such as hydroxy propyl methyl cellulose, sodium carboxymethyl cellulose and other water soluble carboxymethyl celluloses. Also useful in specific applications are alginates, hydroxy methyl cellulose and hydroxy propyl cellulose. Other polymers could include polyacrylic acids, polyethelene oxides and polyvinyl alcohols. Optionally, the water soluble polymeric base can be formulated with a number of starches and carrageenans to modify performance.
(ii) Surfactant active and wetting agent—There are many possible agents that could be used in this case including anionic surfactants, nonionic surfactants, amphoteric surfactants and combinations of these. Common surfactants such as sodium lauryl sulphate, and sodium laureth sulphate can ideally be used but some key individual surfactants are as follows (these could be adjusted as required for the specific functionality of the product and may be combined with emulsifiers and esters): Secondary alkane sulfonate, cocoyl gluconate, lauroyl glutamate, methyl tauride, sodium cocoyl isethionate, tributyl ether sulfate, C12-C16 alcohol ethoxylate, Iso-C10 alcohol ethoxylate, C11 alcohol ethoxylate, cocamidopropyl betaine,
(iii) A small amount of a plasticizer is essential to prevent brittleness and to impart desired physical characteristics to the final film composition. For this purpose, polyol plasticers, emulsifiers and other agents may be added to modify the characteristics of the film and improve production and product performance, etc.

As with commercial soaps and detergents in bulk form, the film delivery strips according to the invention may also include any of a wide number of modifying agents. These would include colors, flavors, moisturizers, skin conditioners and fragrances. There is a very wide range of products that could find use as modifying agents, depending on the exact requirements of the product. For example, for moisturizing soap films, vegetable oils and other emolients such as aloe and lanolin could be used, as is the case in known personal wash formulations.

Modifiers could also include antimicrobial agents such as chlorhexidine and its salts, chloroxylenol including parachlorometaxylenol (PCMX), hexachlorophene, iodine and iodophors, quaternary ammonium compounds, and triclosan. Depending on the applications it may also be desirous to use emolient esters, talk (talcum powder), silk luster concentrates and various phosphate esters.

Films according to the invention can be prepared in a variety of thicknesses depending upon the specific requirements of the finished product. Usually, the thickness of the film would fall in the range of fifteen to six hundred microns. The burst strength of the film can be modified with the specific bases to meet the requirement of the end product. A typical burst strength range would be between two and fifty psi. Plasticization of the film and the base polymer could be adjusted to meet specific requirements for elongation.

Some specific compositions of detergent and soap strips which I have prepared are given below as examples. All film compositions according to the present invention, however are prepared according to the following general process:
-1- The polymer bas is added to either hot or cold water and mixed until it forms a smooth, homogeneous slurry.
-2- Any modifying agents are then added including surfactants, oils, emulsifiers, antimicrobial agents, moisturizers, plasticizers, colors and fragrances as required.
-3- The batch is mixed completely until a homogeneous slurry is obtained. Depending on the specific product requirements, the film is either degassed or mixed to contain dissolved oxygen.
-4- The solution is then cast onto a belt and dried to the required moisture level of the finished product, which is typically 5 to 10 percent by weight.
-5- The product can be cast in a number of different ways including using a standard box casting system, an extrusion die, or a roll coater depending on the system configurations and the product requirements.
-6- It is also possible to foam the film using air, nitrogen or other gases.
-7- The film can be extruded on either a belt system—stainless steel or other good heat conductors or the material can alternatively be run on a carrier film such as coated paper, mylar or oriented polypropylene/PET depending on the specific requirements.
-8- The carrier film can also be used to transfer a surface texture to the product or may be used to transfer a coloring agent as required.
-9- Films may also be dusted to prevent sticking together with a suitable agent such as vegetable starch, or talc. (Talcum powder)
-10- The finished film can then be cut embossed, printed, and further processed as is required for the final end product.

### EXAMPLES

The examples below illustrate specific compositions within the present invention.

### Example 1

### Household Cleaner Composition

| INGREDIENT | % |
|---|---|
| Water | 10-15 |
| Sodium Carboxymethyl cellulose | 15-30 |
| Sodium Laureth Sulfate | 35-60 |
| Propylene Glycol | 4-7 |
| Fragrance | 1-4 |
| Color | 0.1-0.4 |

### Example 2

### Detergent Strips

| | |
|---|---|
| Water | 10 |
| Hydroxy propyl methyl cellulose (low mw) | 20-25 |
| Glycerin | 5 |
| Surfactant blend | 50-70 |
| (sodium lauryl sulphate, alkylaryl ethoxylate carboxylic acid) | |
| Fragrance | 1 |

The two formulations above would be used for general household cleaning products. The appropriate amount of film would be added to, say, a bucket of hot water to produce the cleaning solution.

### Example 3

### Non-Foaming Detergent Strips

| | |
|---|---|
| Water | 10% |
| Hydroxy proply methyl cellulose | 30% |
| Iso-c10 Alcohol alkoxylate | 30% |
| Polyethylene Glycol | 10% |
| Iso-C13 Alcohol Ethoxylate | 20% |

The above formulation is useful in applications where a large amount of foam is not desirable, for example, as dish detergent in strip form for use in a dishwashing machine.

### Example 4

### Soap Strip

| | |
|---|---|
| Water | 10 |
| Carboxy methyl cellulose | 15-30 |
| Clycerin | 2 |
| Liquid Soap - (Ivory ™ Gel) | 28-50 |

### Example 5

### Soap Strip

| | |
|---|---|
| Water | 10-15 |
| Hydroxypropyl methyl cellulose | 8-20 |
| Tapioca Starch | 1-5 |
| Soap Chips | 35-55 |
| Propylene Glycol | 5-10 |
| Fragrance | 1-4.5 |
| Color | 0.1-2 |

### Example 6

### Soap Strip

| | |
|---|---|
| Water | 10-15 |
| Hydroxypropyl methyl cellulose | 8-20 |
| Tapioca Starch | 1-5 |
| Soap Chips (Surfactant - | 45-55 |
| Sodium cocoyl isethionate) | |
| Co-Surfactant (cocoamidipropyl betaine) | 5-10 |
| Propylene Glycol | 5-10 |
| Fragrance | 1-4.5 |
| Color | 0.1-2 |

Examples 4 and 5 illustrate soap strips for use as hand soap in personal hygiene. It will be understood that the formulation of rapid-dissolving film-form compositions using base polymers of the kind described herein will have application to a large number and wide variety of surfactants beyond those specifically illustrated by example in the description of the invention. Accordingly, the scope of the invention is defined by the following claims.

1. A rapidly water soluble film-form composition for the delivery of a surfactant, upon the addition of water, comprising
(i) a water soluble polymeric base carrier selected from the group consisting of carbohydrate based hydrocolloids, alginates, hydroxy ethel cellulose, hydroxy propyl cellulose, polyvinyl alcohol, polyacrylic acid and polyethelene oxide;
(ii) up to seventy percent by weight of a surfactant;
(iii) from five to fifteen percent by weight of water; and
(iv) sufficient plasticizer to impart a desired degree of flexibility to the film.

2. A composition according to claim 1, wherein said carbohydrate based hydrocolloid is selected from carboxymethyl cellulose, sodium carboxymethyl cellulose and hydroxy propyl methyl cellulose.

3. A composition according to claim 2, wherein said surfactant is a personal hygiene soap.

4. A composition according to claim 2, wherein said surfactant comprises a soap and a co-surfactant.

5. A composition according to claim 3, wherein said plasticizer comprises up to ten percent by weight of propylene glycol or glycerin.

6. A composition according to claim 2, wherein said surfactant is sodium lauryl sulphate, sodium laureth sulphate or mixtures thereof.

7. A composition according to claim 5, wherein said plasticizer comprises up to ten percent by weight of polypropylene glycol or glycerin.

8. A composition according to claim 2, further comprising minor amounts of one or more film modifying agent selected from the group consisting of co-surfactants, colors and fragrances.
